(19) United States
(12) Patent Application Publication
(10) Pub. No.: US 2005/0075983 A1
(43) Pub. Date: Apr. 7, 2005

(54) Method of, and system for enforcing jurisdiction in online services

(76) Inventor: Danny St.-Denis, Windsor (CA)

Correspondence Address: WELSH & KATZ, LTD, 120 S RIVERSIDE PLAZA, 22ND FLOOR, CHICAGO, IL, 60606, US

(21) Appl. No.: 10/680,442

(22) Filed: Oct. 7, 2003

(51) Int. Cl. G06F 17/60

(52) U.S. Cl. 705/64

(57) ABSTRACT

The Internet provides tremendous opportunities for new online services, including online gaming and amusement services. Many of these services should be distributed and managed on a geographic basis, yet the Internet allows access to everyone who is online. This results in increased costs as the service provide must provide unnecessary bandwidth and server resources to handle all of the undesirable accessors. The invention provides a means for limiting access to a select group of End Users by who are within the “implied jurisdiction” of the Web site. When attempting to access an electronic service, End Users are challenged to provide secure, personal identification which demonstrates that they are within the implied jurisdiction of the service. In other words, End Users must provide some form of identification (such as a driver's permit) which shows by implication, that they should be able to access all other services offered online by the state.

The present invention relates generally to computers and communications, and more specifically, to a method of, and system for enforcing jurisdiction in the provision of on-line electronic services. An example of such a service is that of betting and gaming over computer networks.

### BACKGROUND OF THE INVENTION

It is well known that data communication networks such as the Internet, Wide Area Networks (WANs) and Local Area Networks (LANs), offer tremendously efficient means of organizing and distributing computerized data. These efficiencies have resulted in their widespread use for both business and personal applications. For example, the Internet is now a common medium for operating online auctions, academic and public forums, distributing publications such as newspapers and magazines, and performing electronic commerce and electronic mail transactions.

The almost pervasive use of, and access to, computer networks such as the Internet has had a major impact on geographically based legal structures. Gambling, retail sales taxes, income taxes and the provision of government services, for example, were all geographically controlled and administered prior to the advent of the Internet. Retail sales taxes for example, were charged to purchasers at the physical point of sale. When products were sold and shipped to an out of state or out of province buyer, retail sales taxes were not applied.

In the past, such out of state sales made up a very small portion of a typical business so the state was not particularly worried about accounting for such sales taxes. Today however, online sales result in vast numbers of interstate and even international sales. There is therefore an interest in obtaining revenues from these retail sales transactions.

As another example, many governments provide online information and other services for various subjects from health issues such as quitting smoking, to business advice for new entrepreneurs. On the Internet, a vast audience can access this information. A large part of this audience may not be paying taxes in the jurisdiction of the government or government agency, thus, resources (such as additional bandwidth and server processing capacity) are being invested to provide these electronic services to non-taxpayers. As well, providing these services to non-taxpayers decreases the access speed and reliability of the service for legitimate taxpayers.

There is therefore a clear interest in managing geographically-based legal structures which large computer networks such as the Internet, have been undermining.

Another type of transaction for which the Internet appears particularly attractive is on-line gaming. Current gaming and betting systems require some manner of direct interaction in a common physical location, for example: casinos, bingo halls, video lottery terminals, sports betting halls and the like. However, it is not always possible for interested participants to visit such establishments. People who are confined to a hospital or nursing home, for example, cannot physically attend a bingo hall. Of course, operators of casinos and betting services would also like their clientele to have easier, twenty-four hour access to their services, which on-line systems would easily accommodate.

Because gambling is a regulated industry all over the world, one cannot simply create an on-line gambling site without regard for the regulations. These regulations are set by individual nations or states, and vary from total prohibition, to nearly complete permissive wagering on almost unlimited subject matter. In the United States, for example, individual states have the authority to regulate gambling within their state borders. State-sanctioned lotteries, casinos, bingo halls, card parlours, and betting on horse racing are but a few examples. These activities are governed by a Gambling Commission in each state, who controls the licensing of all games and businesses permitted to offer games.

Internationally, the scene is much the same; that is, individual nations and states regulate gambling within their borders.

In order to regulate and enforce the gaming industry, it has traditionally been necessary to identify where the gambling occurs and who the parties are. This is of particular concern relative to remote gambling transactions made using a wide area communication network such as the Internet.

FIG. 1 presents an exemplary layout of an Internet communications system 30. The Internet 32 itself is represented by a number of routers 34 interconnected by an Internet backbone 36 network designed for high-speed transport of large amounts of data. End User's computers 38 may access the Internet in a number of manners including modulating and demodulating data over a telephone line using audio frequencies, which requires a modem 40 and connection to the Public Switched Telephone Network 42, which in turn connects to the Internet 32 via an Internet Service Provider 44. Another manner of connection is the use of set top boxes 50 which modulate and demodulate data onto high frequencies which pass over existing telephone or television cable networks 52 and are connected directly to the Internet via Hi-Speed Internet Service Provider 54. Generally, these high frequency signals are transmitted outside the frequencies of existing services passing over these telephone or television cable networks 52.

Web sites are maintained on servers 56 also connected to the Internet 32 which provide content and applications to the End User's computers 38. Communications between End User's computers 38 and the rest of the network 30 are standardized by means of defined communication protocols.

Internet Service Providers (ISPs) 44, 54 or Internet Access Providers (IAPs), are companies that provide access to the Internet. ISPs 44, 54 are considered by some to be distinguished from IAPs in that they also provide content and services to their subscribers, but in the context of this disclosure the distinction is irrelevant. For a monthly fee, ISPs 44, 54 generally provider end users with the necessary software, user name, password and physical access. Equipped with a telephone line modem 40 or set top box 50, one can then log on to the Internet 32 and browse the World Wide Web, and send and receive e-mail.

FIG. 1 is something of a simplification, as ISPs are often connected to the Internet 32 through Network Access Points (NAPs), rather than directly as shown in FIG. 1. As well, the Internet itself is far more complex than that shown in FIG. 1, consisting of a vast interconnection of computers, servers, routers, computer networks and public telecommunication networks which allows two parties to communicate via whatever entities happen to be interconnected at any particular time. However, these details would be well known to one skilled in the art.

Prior to today's widespread accessibility to the Internet, remote gaming and betting had to be implemented in a “hard-wired” manner to ensure participants were located within an acceptable jurisdiction. This required the establishment of complicated and expensive secured virtual private networks (VPN), secure wide area networks (WANs), or private telephone lines. Such techniques are known in the art and will not be described in detail herein.

The important point is that these hard-wired networks were costly and complex, and could not be easily setup or modified. Therefore, they could not be applied to participants with a casual interest in the gaming activity.

With the pervasiveness of the Internet, a large number of on-line gaming and betting services have recently appeared. Typically, these services use very weak techniques to verify the geographical location of customers, which may explain why many of these services have located themselves beyond the legal reach of regulators in their main markets. For example, many on-line casinos directed towards the United States market are located in Antigua, Belize and Dominican Republic.

These systems generally ask the End User to supply a street address which confirms they are currently in the acceptable jurisdiction. Some services even verify the End User's name, telephone number and address against a database to confirm that they should be allowed to use the service, but such controls can be circumvented simply by the End User entering a valid set of personal data for someone else in the acceptable geographic area. Such approaches are therefore completely ineffective against a determined End User.

It has been proposed that databases be created which will provide geographic locations based on the IP address of the End User. In addition to the cost of creating and maintaining these databases, which would require continuous modification and updating, this approach requires the End User's actual IP address, which raises privacy concerns. Furthermore, many ISPs use Dynamic Host Configuration Protocol (DHCP) which dynamically assigns IP addresses to subscribers when they call up. Therefore, a device can have a different IP address every time it connects to the network, and in some systems, the device's IP address can even change while it is still connected. Because the End User is not associated with a unique IP address, the IP address does not reliably correspond with the geographic location of an End User.

Another approach is to use the existing global positioning system (GPS) to identify the geographic location of End Users. The GPS is a system of 24 satellites for identifying earth locations, launched by the U.S. Department of Defense. By triangulation of signals from three of the satellites, a receiving unit can pinpoint its current location anywhere on earth to within a few meters. However, such systems require the End User to install special, expensive hardware and software. Since the GPS equipment is on the End User's premises and out of control of the regulators, it may be subject to tampering. An End User could, for example, alter the data the GPS equipment to indicate that he is residing in any jurisdiction that he wishes.

It has also been proposed that IPv6 be designed to accommodate location information. IPv6 is the next generation IP protocol, which among other things, expands the address space from 32 to 128 bits. Therefore, the address space has sufficient room to include both a backward compatible IP address, as well as geographic data. However, this would require universal agreement or standardization, which has not occurred. As well, IPv6 has not been widely implemented, and will likely require some time to replace the currently pervasive IPv4 legacy hardware and software.

There is therefore a need for enforcing the jurisdiction of geographic location-based services over the Internet and similar networks, provided with consideration for the problems outlined above. None of the existing proposals provide a satisfactory solution. If such a solution can be found, any services which a Web site wishes to restrict to End Users in a certain geographic area, may be restricted. These services may include for example: government publications, help lines, gaming, gambling or counselling services. The system could also be applied to the collection of state and national sales taxes.

### SUMMARY OF THE INVENTION

It is therefore an object of the invention to provide a method and system which obviates or mitigates at least one of the disadvantages described above.

One aspect of the invention is broadly defined as a method of providing electronic services comprising the steps of: offering an electronic service over a network; challenging End Users to provide secure, personal identification which demonstrates that they are within the implied jurisdiction of the service; and responding to the secure, personal identification being acceptable by providing the electronic service.

Another aspect of the invention is defined as a system for providing electronic services over a communication network comprising: an End User computer; an Internet Service Provider (ISP); a Web Server offering an electronic service on a Web site; and a communication network for interconnecting the End User computer, the ISP and the Web Server; the Web Server being operable to: offer an electronic service to an End User via the End User Computer; challenge End Users to provide secure, personal identification which demonstrates that they are within the implied jurisdiction of the service; and respond to the secure, personal identification being acceptable by providing the electronic service to the End User Computer via the communication network and the ISP; the End User computer being operable to: present the challenge to the End User; receive the input secure, personal identification; communicate the input secure, personal identification to the Web server via the communication network and the ISP; and receive the electronic service from the Web server; and the ISP being operable to transport communications between the Web server and the End User Computer.

### BRIEF DESCRIPTION OF THE DRAWINGS

These and other features of the invention will become more apparent from the following description in which reference is made to the appended drawings in which:

FIG. 1 is a physical layout of an exemplary communication network as known in the prior art;

FIG. 2 is a flow chart of a method of enforcing jurisdiction in a broad embodiment of the invention;

FIG. 3 is a block diagram of a system for enforcing jurisdiction in an embodiment of the invention; and

FIG. 4 is a flow chart of a method of enforcing jurisdiction in an embodiment of the invention.

### DETAILED DESCRIPTION OF PREFERRED EMBODIMENTS OF THE INVENTION

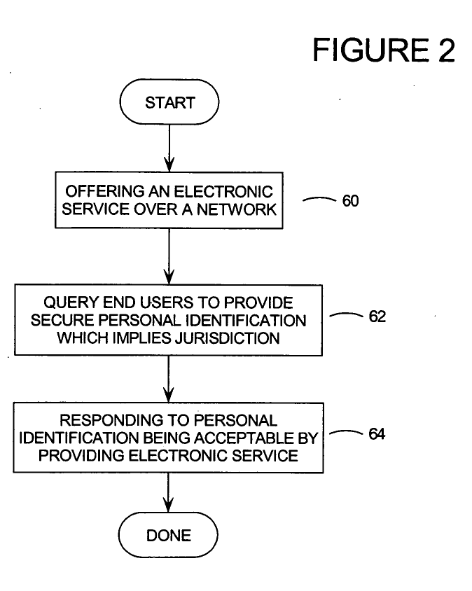

A methodology which addresses the objects outlined above, is presented as a flow chart in FIG. 2. This figure presents a method of providing electronic services which is initiated by an electronic service of some sort, being offered over a communication network at step 60.

The electronic service may be one of many known in the art, including, for example:

online gaming or gambling;

electronic purchasing;

access to documentation;

access to government publications or services; or

access to medical advice.

The communication network may be one of many known in the art, and may consist of several different networks working together, including wireless networks such as cellular telephone networks, the public switched telephone network, cable television networks, the Internet, ATM networks, frame relay networks, local area networks (LANs) and wide area networks (WANs).

The End User may interact with the method of the invention using a number of different devices including a computer, smart terminal, personal digital assistant (PDA), Internet-ready telephone, digital notebook, laptop computer, wearable computer, dedicated gaming device or other similar interface. Such devices are well known in the art.

The electronic service itself will generally be provided by some computerized device such as a Web server, which is supported by whatever computer-based appliances and peripherals are required to provide the service. Such technology is well known in the art, and is not per se, part of the invention.

In response to some manner of a request for the electronic service, a challenge is then issued to the End User at step 62, for him or her to provide secure, personal identification which demonstrates that they are within the implied jurisdiction of the electronic service. Such identification could include, for example:

a driver's license or permit;

a social security or social insurance number;

a health card number;

a passport number;

a military, police force or security identification number;

an employee number;

a business license number; or

a tax exemption number.

Each of these forms of identification is relatively secure as it is not published, nor is it widely distributed. When it is disclosed or used by the End User, it is only done in an environment with either an explicit or at least an implicit degree of confidence. This is in contrast to postal codes, telephone numbers, addresses, license plate numbers, most membership numbers, and credit card numbers, which are either easily available or widely distributed by the End User without much concern for security.

These forms of identification are also personal, in that they are tied to the individual and not to a postal address, a company, club, employer, or the like.

These forms of identification also imply a geographic jurisdiction as the agencies which issue them, do so only on a geographic basis. Driver's permits, for example, are only issued to residents of a given province or state. While the End User may not be physically present in the corresponding province or state at the time during which they are attempting to access the electronic service, it is only a question of how the legal regulation or policy is phrased, which dictates whether this is significant. The tests of many tax and health regulations, for example, turn on the “permanent residence” of the person in question, rather than where the End User happens to physically be when the question of service arises. In Canada, for example, many permanent residents are eligible for coverage under provincial health services even if their illness arises during their annual three-month long stay in another country.

These forms of identification also imply geographic jurisdiction for the purpose of the invention in the sense that they were originally issued to the End User for a different reason. A tax exemption number, for example, is clearly issued to the holder for the purposes of purchasing goods without paying taxes. This is orthogonal to the purpose of the invention—to imply jurisdiction.

Of course, the identification of the invention may be used in conjunction with some other strong password, such as PKI (public key infrastructure) many of which are known in the art. The invention lies in the establishment of jurisdiction, rather than strong access control.

Thus, it is not unreasonable at all, for a state to accept the concept of the invention and to limit the distribution of on-line business advice (for example) to those having a valid, state-issued health care number. The health care number implies that the holder pays taxes in the jurisdiction and therefore should have access to the business advice regardless of where he happens to be physically, at the time the request is made.

Also, note that the “request-challenge” process of step 62 may consist of a large number of steps and communications, or may be quite simple. It may, for example, consist of a single step, where a challenge is automatically issued when the End User attempts to access a certain Web page, such as the home page. In other cases, multiple steps and communications may be performed in the process of authenticating an End User, determining what accounts they may have, determining which of a variety of services they may wish to access, etc.

Finally, at step 64, the Service Provider responds to the secure, personal identification being acceptable by providing the electronic service to the End User. The manner in which this verification is made will depend on the nature of the identification provided. A more detailed discussion of this process is included in the description of the preferred embodiments of the invention which follow.

Similarly, the manner in which the electronic service is provided to the End User, will also vary with the nature of the service. Typical services might include:

downloading single documents to the End User;

allowing the End User to access a certain Web page;

allowing the End User to access a directory of documents or image files;

downloading software to the End User;

establishing a secure communication line between the End User's computer and a particular server; or

allowing the End User to access a particular chat room.

Even allowing access to a single Web page might be quite complex. It is common for Web pages to include text, graphics, audio files, executable applets, data files or attachments such as software files, or other data and files known in the art. The invention is not limited by the nature of the content, and the technology for providing such services are well known in the art.

The invention of FIG. 2 addresses the problems in the art. It allows electronic services to be distributed knowing that only a select group of End Users will be able to access them, in particular, only those End Users who have the necessary secure identification. The provider of the electronic service may determine ahead of time, which types of identification will be considered acceptable, so they have complete control over access to the service.

Such “implied jurisdictional” control will allow service providers to reduce the resources they need to provide their service because they will not have to deal with a vast number of unwanted End Users.

No additional hardware is required as in the case of GPS solutions, and DNS routers do not need to be modified to implement the invention. Therefore, there is no additional cost to the End User and the invention may be applied without affecting the existing network. As well, the invention is independent of whether IPv4 or IPv6 is being used.

Because the “implied jurisdiction” is determined independently of the actual physical location of the End User, the invention does not require the identification of the ISP or the IP address of the End User. Thus, the invention operates with Dynamic Host Configuration Protocol (DHCP) systems, and the End Users need not worry about their personal location or IP address being determined.

Thus, the invention allows twenty-four hour a day, seven day a week access to electronic services such as gaming and amusements without having to be in a particular physical location or geographic area.

The concept of the invention is a marked departure from the traditional notion of legal jurisdiction. Prior to the advent of powerful communication networks such as the Internet, legal jurisdiction worked on a literal and physical basis. For example, gaming could only be done in states allowing gaming because the End User had to be physically present next to the physical machines. In the United States, wire laws prevented gaming from out of state, but those prohibitions were only effective because of the limited access to wire services at the time.

The Internet is far more accessible, so the old wire laws can no longer stop the flood of online users. The invention recognizes this, and rather than railing against the technological change, embraces it and provides a solution which allows the gaming industry to continue being regulated, but in a manner that is aligned with the way the Internet is changing communications paradigms.

Similarly, retail sales tax laws assumed that the vast majority of purchasers would be physically present at the point of sale. The fact that a small percentage of sales would be made across state or provincial lines, and that sales tax could not be collected on these sales, was not a major concern. However, the growing value of electronic commerce is starting to have a significant impact on sales tax revenues, so there is a desire to being collecting such revenues. The invention provides such a mechanism for the collection of such revenues.

It is also notable that in its present form, the invention is employing secure personal identification for a different purpose than it was originally intended to serve. This is not intended to preclude the issuance of new “jurisdiction-based” identification expressly for the purpose of establishing implied jurisdiction.

The invention is clearly distinct from other jurisdiction-dependent methods and systems presently being employed. As noted above, for example, some gaming sites require the End User to enter a valid postal address in the jurisdiction of the gaming site as verification. But postal addresses are:

publicly known and not secure (i.e. they can found in telephone books, voters lists, and the like). Thus, a determined End User can find a postal address that will be accepted by the gaming Web site; and

they are not tied to individuals, but to a physical building, so there is no accountability to individuals.

Other gaming sites require passwords, identification such as credit cards, and other personal information, but there is no inherent tie between these data and geographical location.

Finally, the novelty of the invention is clear from the very fact that many legislative structures, regulations and policies will have to be changed to accommodate the invention and the concept of the “implied jurisdiction”.

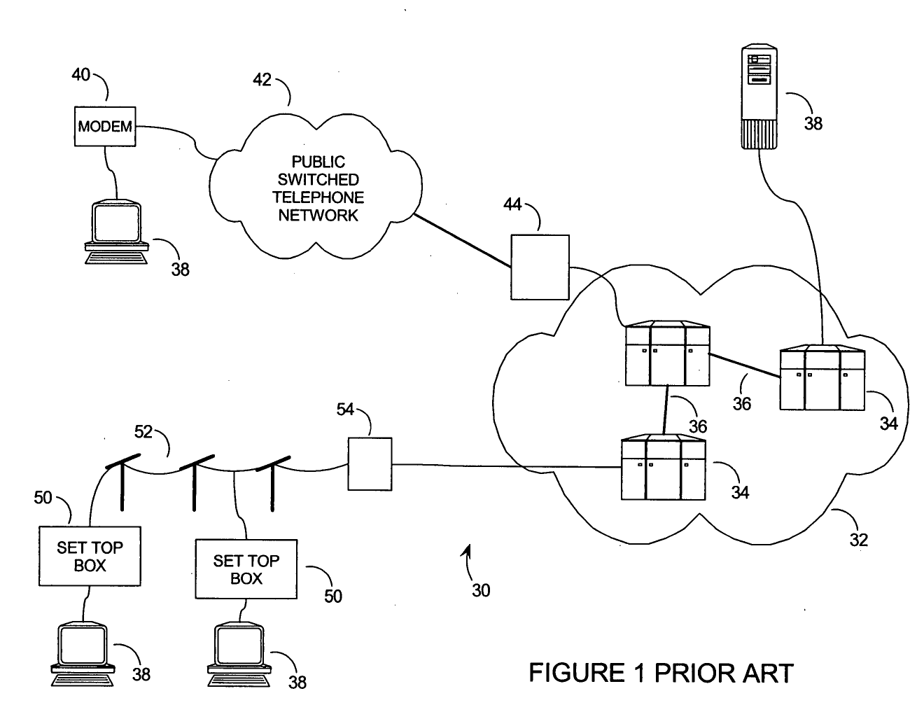

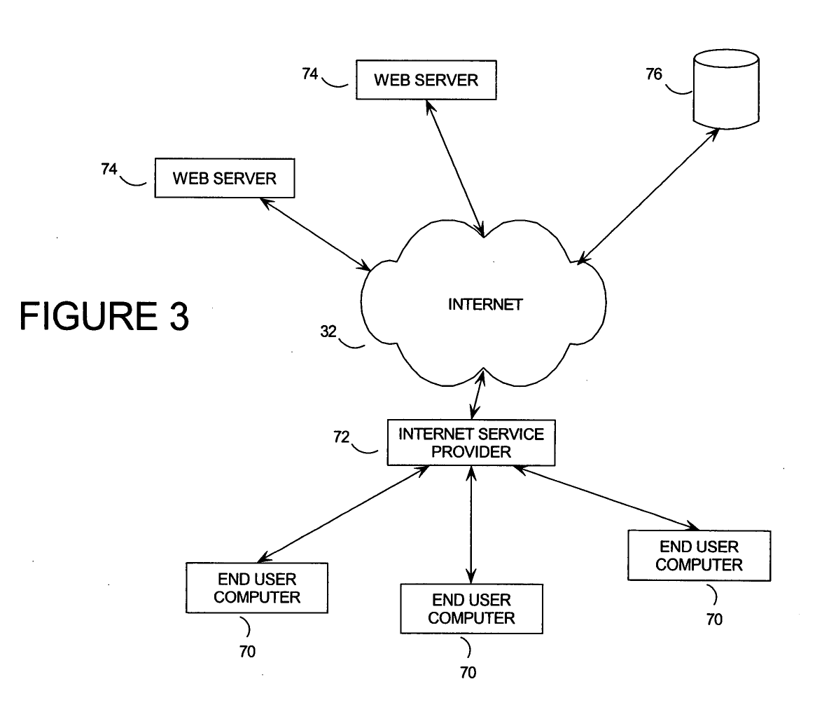

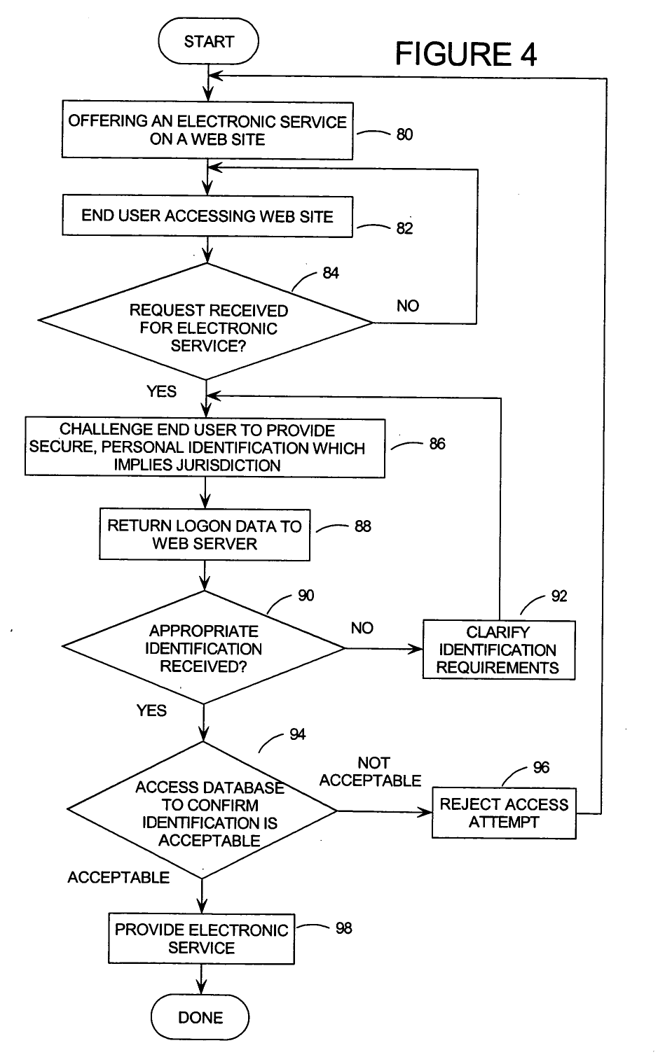

A specific embodiment of the invention is presented by means of the block diagram in FIG. 3, and the flow chart of FIG. 4. FIG. 3 focuses on the relevant parties in an exemplary transaction, and does not present the same level of detail as FIG. 1. FIG. 4 elaborates on the method of FIG. 2, applying it to a more specific application.

A number of End User Computers 70 are presented in FIG. 3, who have access to the Internet 32 via their ISP 72. The End User Computers 70 may employ desk-top computers 38 as in FIG. 1, or other interface devices as known in the art, and as will emerge as technology evolves. These End User Computers 70 may access their ISP 72 in different ways, such as via cable modem, telephone line mode, or wireless methods, which is not limited by the invention.

Via the Internet 32, the End User Computers 70 have access to various Web Servers 74, who provide them with the electronic services that they request. The Web Servers 74, also have access to external databases 76 which contain data on the secure identification which the End Users 70 provide, so that this information can be authenticated.

The information stored on the external databases 76 could be stored locally on the Web Servers 74 but this would be a less secure implementation. Preferably, the Web Servers 74 would only store secure identification while it is being authenticated—it would be destroyed immediately thereafter, as the Web Servers 74 no longer have any use for it. If the Web Servers 74 stored all of the data on the external database 76 locally, they would become a high value target for attack both from the outside and from within.

A more detailed implementation of the invention with respect to an Internet application, is presented in the flow chart of FIG. 4. This method begins with a Web server establishing a Web site at step 80, which includes an electronic service of some sort.

The End User then accesses the Web site on the Web Server 74 at step 82. This step will generally be effected by the End User searching through the resources of the World Wide Web using his Web Browser, though he may also know the address of the Web site ahead of time.

A Web Browser is an application program that runs on the End User's computer 70 and provides a way to look at and interact with all the information on the World Wide Web. When the End User enters file requests by either “opening” a Web file, typing in a Uniform Resource Locator (URL), clicking on a previously bookmarked URL or clicking on a hypertext link, the Web browser builds an HTTP request and sends it to the Internet Protocol address indicated by the URL. The HTTP software in the destination server machine receives the request and, after any necessary processing, the requested file is returned.

The Hypertext Transfer Protocol (HTTP) is the set of rules for exchanging files on the World Wide Web, including text, graphic images, sound, video, and other multimedia files. HTTP also allows files to contain references to other files whose selection will elicit additional transfer requests (hypertext links). Typically, the HTTP software on a Web server machine is designed to wait for HTTP requests and handle them when they arrive.

Next, at step 84, the Web server 74 waits until a request is made by the End User to receive a certain electronic service. This representation is a simplification of how a Web site actually operates, as there generally is no explicit control loop as shown in FIG. 4. Generally, the End User Computer 70 monitors the keyboard and mouse for entries and clicks. When an entry or click is identified as a request for a certain service on the Web page, an HTTP message is sent to the Web server 74 for action.

If a request for the electronic service is issued by the End User Computer 70, then the Web server 74 will issue a challenge to the End User at step 86, to provide secure, personal identification which implies jurisdiction. As part of this step, the Web server 74 may also request other access information such as an account name or number, password, personal identification number and/or digital signature. Such information is well known and is commonly used as part of the step of accessing or “logging onto” Web sites. The steps for logging on to a Web site may vary from application to application, and are well known in the art.

The End User then enters the requested data in the fields of the Web page it has received, and returns the data to the Web Server 74 at step 88.

At step 90, the Web Server 74 receives the logon data from the End User and confirms that it meets with general requirements such as all of the requested information being provided, and that the data include the correct number and type of characters. This step may also include the step of authenticating the End User's identity with respect to a local database (via an account name and password for example). If the data is unacceptable, the routine may clarify the identification requirements to the End User at step 92, or it may simply end the routine and return to the home page of the Web Site.

If the logon data meets the preliminary requirements, the process proceeds to step 94, where the Web Server 74 confirms that the secure, personal identification which implies jurisdiction, is acceptable. This will typically be done by sending a request to an external database or Server, for confirmation. If the secure, personal identification is unacceptable, the access attempt is rejected at step 96. Otherwise, the access attempt is accepted and the electronic service delivered to the End User at step 98 and the routine is completed.

If the secure, personal identification is found to be acceptable at step 94 then the routine proceeds to provide whatever electronic service has been requested, at step 98. The provision of the electronic service at step 98 might consist of a single step or many steps.

In the case of an electronic gaming site, for example, it might consist of the following steps:

1. the End User being prompted to select a game. Typically, the software routine will sit in a loop until such a selection is made;

2. the Web Server 74 determining whether the End User has sufficient funds to play the requested game. If not, access is denied;

3. the game is then played, which on its own, may take many steps; and

4. after the completion of the game, the Web server 74 makes whatever adjustments are necessary to the End User's account, crediting or debiting his account in respect of the wins or losses in the game. Generally, these accounts are managed using debit cards and credit cards, but many other systems could be used such as prepaid accounts or smart cards

This routine may also be repeated for other games, or the End User may decide to close his account and exit the Web site.

Such a routine might be used for a Web site providing amusement games, games of chance, for betting or entertainment purposes, including without limitation: video lottery terminals, keno, roulette, dice games such as craps, ma jong, jai lai, pai gow, horse racing, dog racing, lotteries, slot machines, baseball, football, golf, basketball, fantasy sports leagues and fantasy sports games, and card games which may include poker, black jack, solitaire, and baccarat.

Other applications may use different routines, but their implementations would be clear to one skilled in the art from the teachings herein.

While particular embodiments of the present invention have been shown and described, it is clear that changes and modifications may be made to such embodiments without departing from the true scope and spirit of the invention. The invention has been described with respect to specific examples, though it would be clear to one skilled in the art that the invention may be applied to many other applications.

For example, a government agency may distribute a notebook which is pre-loaded with text and graphic content, as well as a set of implied jurisdiction passwords. Thus, End Users would only be able to access the content if they had an acceptable implied jurisdiction password.

In the preferred embodiment, all Internet communications are to be encrypted as a security precaution, using one of many techniques known in the art; at the very least, the secure, personal identification should be communicated in an encrypted manner. Currently, the preferred method is that of public-key/private-key encryption. Encryption preserves the privacy of the transactions, prevents tampering with the game or results, and protects against unauthorized access to a player's financial accounts.

It is also preferred that the Web Servers 74 be protected with anti-virus software and firewalls, as known in the art. Similarly, End User Computers 70 should also have appropriate protection against viruses, worms, attackers, and the like.

The method steps of the invention may be embodiment in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory medium such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

1. A method of providing electronic services comprising the steps of:
offering an electronic service over a network;
challenging End Users to provide secure, personal identification which demonstrates that they are within the implied jurisdiction of the service; and
responding to said secure, personal identification being acceptable by providing said electronic service.

2. The method as claimed in claim 1, wherein said communication network comprises an Internet network.

3. The method of claim 2 in which said step of responding comprises the step of:
accessing a database on a remote Web server, via said Internet network, to determine whether said secure, personal identification is acceptable.

4. The method of claim 3 in which said electronic service is one selected from the group consisting of:
online gaming;
electronic purchasing;
access to documentation; or
access to medical advice.

5. The method of claim 3 in which said secure, personal identification is one selected from the group consisting of:
a drivers license;
a drivers permit;
a social security card;
a social insurance number;
a health card number;
a passport number;
a business license number; or
a tax exemption number.

6. The method of claim 3 in which said secure, personal identification is only communicated in an encrypted form.

7. The method of claim 3 in which said steps of offering, requiring and responding are performed on a web server.

8. The method of claim 3 in which said web server is protected with a fire wall.

9. The method of claim 3, wherein said step of sending a request further comprises sending an account name and password.

10. A method of providing electronic services comprising the steps of:
offering an electronic service on a Web site;
responding to a request for access to said electronic service by an End User, by:
challenging said End User to provide secure, personal identification which demonstrates that he is within the implied jurisdiction of the electronic service; and
responding to said secure, personal identification being received by:
accessing a database on a remote Web server, via the Internet, to determine whether said secure, personal identification is acceptable;
responding to said secure, personal identification being acceptable by providing said electronic service to said End User; and
responding to said secure, personal identification being unacceptable by rejecting said request for access to said electronic service by an End User.

11. A system for providing electronic services over a communication network comprising:
an End User computer;
an Internet Service Provider (ISP);
a Web Server offering an electronic service on a Web site; and
a communication network for interconnecting said End User computer, said ISP and said Web Server;
said Web Server being operable to:
offer an electronic service to an End User via said End User Computer;
challenge End Users to provide secure, personal identification which demonstrates that they are within the implied jurisdiction of the service; and
respond to said secure, personal identification being acceptable by providing said electronic service to said End User Computer via said communication network and said ISP;
said End User computer being operable to:
present said challenge to said End User;
receive said input secure, personal identification;
communicate said input secure, personal identification to said Web server via said communication network and said ISP; and
receive said electronic service from said Web server; and
said ISP being operable to transport communications between said Web server and said End User Computer.
